(19) United States
(12) Patent Application Publication
(10) Pub. No.: US 2014/0166117 A1
(43) Pub. Date: Jun. 19, 2014

(54) SPLIT RANGE CONTROL FOR PRESSURIZATION

(71) Applicant: Ingela Lind, Linkoeping (SE)

(72) Inventor: Ingela Lind, Linkoeping (SE)

(73) Assignee: SAAB AB, Linkoeping (SE)

(21) Appl. No.: 14/234,664

(22) PCT Filed: Aug. 16, 2011
(86) PCT No.: PCT/SE2011/050994

§ 371 Date: Jan. 31, 2014

(51) Int. Cl. B64D 37/10; B64D 37/32

(52) U.S. Cl. CPC B64D 37/10; B64D 37/32
USPC 137/14; 137/211; 137/899.4; 220/88.3

(57) ABSTRACT

The invention aims at pressurising a volume (2) that needs to have a relative air pressure, in comparison with an ambient pressure, where the ambient air pressure can change rapidly and with large amplitude and where the access to pressurised air is limited. This is solved by a half open system comprising two parallel regulators (9) and (17) and two ejectors (15) and (19) working according to a split range control principle. When the relative air pressure difference is above a desired value of the second regulator (17), only the first regulator and the first ejector work. When the relative air pressure difference is below the desired value of the second regulator (17), both regulators (9) and (17) and ejectors (15) and (19) work. In this way the pressure inside the volume (2) can adapt rapidly to the changes in the ambient pressure, without leaking too much air during a static condition.

### TECHNICAL FIELD

The present invention relates to a method and a system for pressurising volumes that need to have a relative air pressure, in comparison with an ambient pressure, where the ambient air pressure can change rapidly and with large amplitude and where the access to pressurised air is limited.

### BACKGROUND ART

It is preferable on aircrafts to have as large fuel tanks as possible in order to maximize the possible distance to be covered. However, larger tanks bring about other inconveniencies.

In especially fighter aircrafts the ambient pressure can change rapidly due to e.g. a sudden dive. The rapid change between the pressure inside the tank and the pressure outside the tank can result in tank structural damage, which might permanently destroy the aircraft. It is therefore important that the pressure inside the tank can be adapted rapidly to the ambient pressure.

It is also desirable to keep a light overpressure inside the tank relative to the ambient pressure because if the pressure inside the tank is too low the fuel will evaporate. If the tank is large and the amount of fuel in the tank is low, a considerable air flow will be needed in order to control the pressure in the tank. The amount of pressurised air, which can be used for tank pressurisation, in an aircraft is normally limited, because pressurised air is also used for e.g. cooling.

There are two principally different solutions to regulate the pressure inside the fuel tank of an aircraft, an open regulating system and a closed regulating system. The closed systems have an active regulation on both the air inflow and on the air outflow by means of regulators and pressure steered valves. The open regulating systems have only regulation on the air inlet while the air outflow passes through a non variable throttling. The closed regulating systems need complicated devices in order to function properly. It increases the overall weight of the aircraft and it requires a great deal of redundancy in order to obtain a safe system. The open regulating systems are simpler. However, since the tank constantly leaks air, independently of the air pressure within the tank, the demand for pressurised air into the tank will be considerable and may also lead to an increase in overall weight of the aircraft.

If the regulated inflow passes through the same throttling as used for the non-regulated outflow, the solution is referred to as a half-open regulating system. Half-open regulating systems are a compromise that uses the inflow to block the outflow. The size of the throttling is static and normally dimensioned by the flow that is needed to keep the pressure within an admissible interval. With a large opening air can quickly be pumped into the tank or leave the tank which makes it possible to rapidly change the pressure inside the tank. This is especially necessary when the aircraft performs a diving manoeuvre which results in a sudden increase of the ambient pressure and air has to be pumped very rapidly into the tank.

In a static situation, however, when the ambient pressure is almost constant and there is no need to change the pressure inside the tank, a small opening, which requires a smaller inflow to block the outflow, is preferable.

### DEFINITIONS

It shall be noted that through this application the expression “upstream” refers to devises arranged closer to the source of pressurised air and the expression “downstream” refers to devises arranged closer to the volume. Through this application the expressions “upper” and “lower” refer uniquely to the position in the figures and has nothing to do with the airflow.

### SUMMARY OF THE INVENTION

The object of the present invention is to overcome the above mentioned weaknesses of the known technology.

A further object of the present invention is to create a method and a system for pressurising large volumes that need to have a relative air pressure, in comparison with an ambient pressure, within a specified interval where the ambient air pressure can change rapidly and with large amplitude and where the access to pressurised air is limited.

Another object of the present invention is to create a system that is reliable and easy to maintain.

Still a further object of the present invention is to create a system that has a low weight.

These objects are achieved with a system for pressurising a volume according to the characterizing parts of claim 1. The invention defines a system for pressurising a volume that need to have a relative air pressure, in comparison with an ambient pressure, within a specified interval, comprising a source of pressurised air, a conduit system for delivering pressurized air from the source into the volume, a first sensor which is arranged to measure the pressure inside the volume, a second sensor which is arranged to measure the ambient pressure, a first regulator arranged on a first part of the conduit system, which regulator is arranged to regulate a first airflow, from the source of pressurised air to the volume through the first part of the conduit system, in order to obtain a first relative pressure difference value between the pressure inside the volume and the ambient pressure. The system also comprises a first ejector arranged on the first part of the conduit system, downstream of the first regulator, a second regulator which is arranged in parallel to the first regulator and the first ejector on a second part of the conduit system and which is arranged to regulate a second flow, from the source of pressurised air to the volume through the second part of the conduit system, in order to obtain a second relative pressure difference value between the pressure inside the volume and the ambient pressure, a second ejector arranged on the second part of the conduit system, downstream of the second regulator and an upper check valve arranged on the second part of the conduit system downstream of the second ejector, blocking airflow from the volume into the second ejector.

The present invention further defines a method for pressurising a volume that needs to have a relative air pressure, in comparison with an ambient pressure, within a specified interval comprising the steps of:
measuring the pressure within the volume,
measuring the ambient pressure outside of the volume,
if the pressure difference between the pressure inside the volume and the pressure outside of the volume exceeds a first relative pressure difference value
relieving the air pressure within the volume by letting air flow out from the volume through a first ejector,
if the pressure difference between the pressure inside the volume and the pressure outside of the volume is below the first relative pressure difference value
using a first regulator arranged upstream of the first ejector to regulate a first airflow from a source of pressurised air through the first regulator into the volume in order to obtain the first relative pressure difference value between the pressure inside the volume and the ambient pressure,
using the airflow through the first ejector to suck in additional ambient air through the first ejector and add it to the first airflow into the volume,
if the pressure difference between the pressure inside the volume and the pressure outside of the volume is below a second relative pressure difference value, which is lower than the first relative pressure difference value
using a second regulator arranged in parallel to the first regulator and the first ejector to regulate a second airflow through the second regulator into the volume in order to obtain the second relative pressure difference value between the pressure inside the volume and the ambient pressure,
using the airflow through a second ejector, which is arranged downstream of the second regulator, to suck in additional ambient air through the second ejector and add it to the second airflow into the volume.

The present invention has the effect that it is possible to increase the volume without having to increase the amount of pressurised air during a static condition and only having to increase the amount of pressurised air moderately during a transient condition. The system is relatively simple, which minimizes the failure rate and the maintenance burden. It also has a relatively low weight.

The present invention further defines a lower check valve arranged on a third part of the conduit system, which is arranged downstream of the two regulators and connects the first part of the conduit system with the second part for the conduit system. The effect of this check valve is that a flow connection can be established between the second regulator and the first ejector. This means that the system still works, although not perfectly, if one of the regulators fail.

The present invention further defines a security valve, which relieves air when, for some reason, the pressure inside the volume is much higher than the ambient pressure and reaches dangerous levels. The effect of this security valve is that the probability of a tank explosion is minimized.

### BRIEF DESCRIPTION OF THE DRAWINGS

Further advantages and features of the present invention can be derived from the following detailed description of exemplary embodiments of the invention, with reference to the drawings.

FIG. 1 shows a principal scheme of a pressurising system according to the prior art when the pressure inside the tank is too low.

FIG. 2 shows the principle of an ejector acting as a pump.

FIG. 3 shows the principle of an ejector acting as an outlet.

FIG. 4 shows a principal scheme of a pressurising system according to the prior art when the pressure inside the tank is too high.

FIG. 5 shows a principal scheme of a pressurising system according to the prior art when the relative pressure difference between the pressure inside the tank and the pressure outside the tank is static.

FIG. 6 shows a principal scheme of a pressurising system according to the present invention when the relative pressure difference is below the first relative pressure difference value but above the second relative pressure difference value.

FIG. 7 shows a principal scheme of a pressurising system according to the present invention when the relative pressure difference is above the first relative pressure difference value.

FIG. 8 shows a principal scheme of a pressurising system according to the present invention when the relative pressure difference lies more or less statically on the first relative pressure difference value.

FIG. 9 shows a principal scheme of a pressurising system according to the present invention when the relative pressure difference is below the second relative pressure difference value.

FIG. 10 shows a principal scheme of a pressurising system according to the present invention when the relative pressure difference is below the second relative pressure difference value and the first regulator is failing.

FIG. 11 shows a coordinate system pointing out different relative pressure difference values.

FIG. 12 shows a principal scheme of a pressurising system according to the invention when it is used on an aircraft.

### DETAILED DESCRIPTION

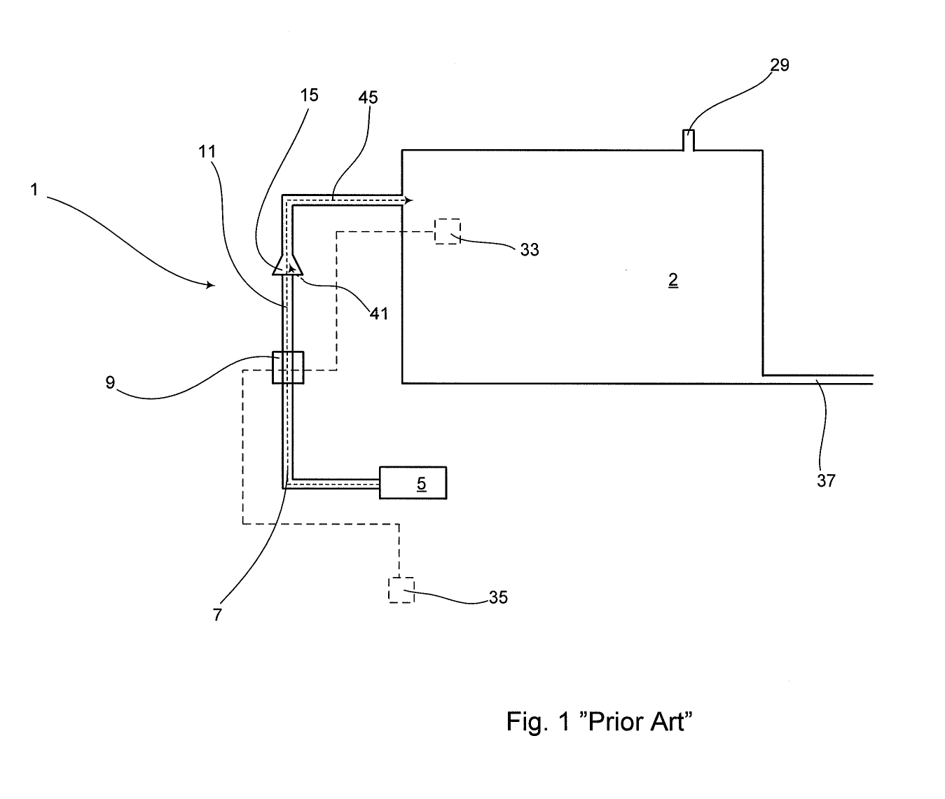

With reference to FIG. 1, an example of a pressurising system according to the prior art is generally depicted. The system comprises a volume 2, which in this figure is a fuel tank on an aircraft. The fuel tank 2 comprises fuel and air and has a fuel outlet 37 for furnishing fuel to the engines. The system intends to keep a moderate overpressure in the fuel tank 2 in comparison to the ambient pressure. For this purpose the system comprises a source of pressurised air 5, which pumps air into the fuel tank through a conduit system 7 when the pressure in the fuel tank is too low. It also comprises two pressure sensors, 33 and 35, which measure the pressure inside the fuel tank and the ambient pressure. The system is a half-open regulating system. The air flowing into the fuel tank 2 is regulated by means of a regulator 9 which uses the measurement results from the sensors 33 and 35 for the control of the flow 11 towards the volume. The regulator 9 tries to keep the relative pressure difference between the pressure inside the tank and the ambient pressure on a desired value. When the pressure inside the tank is too low, additional air has to be fed from the source of pressurised air 5 and when the pressure is too high air has to leak out from the tank 2.

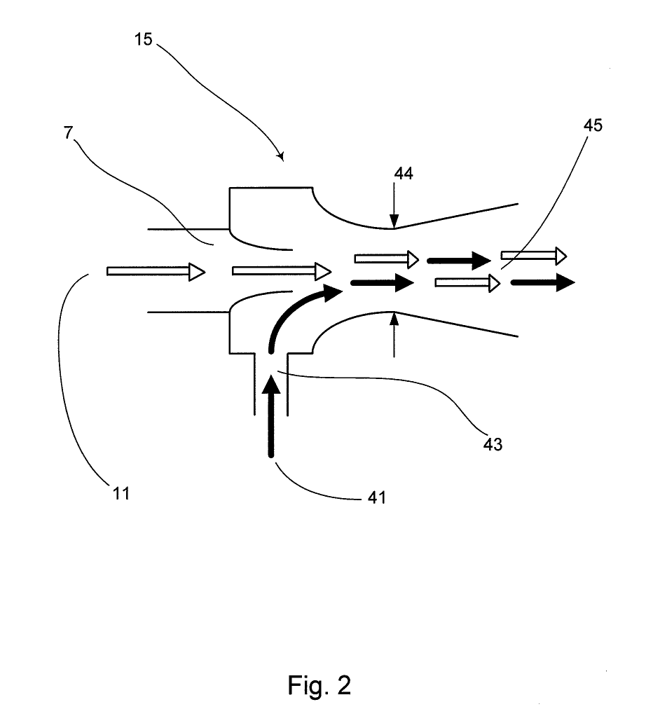

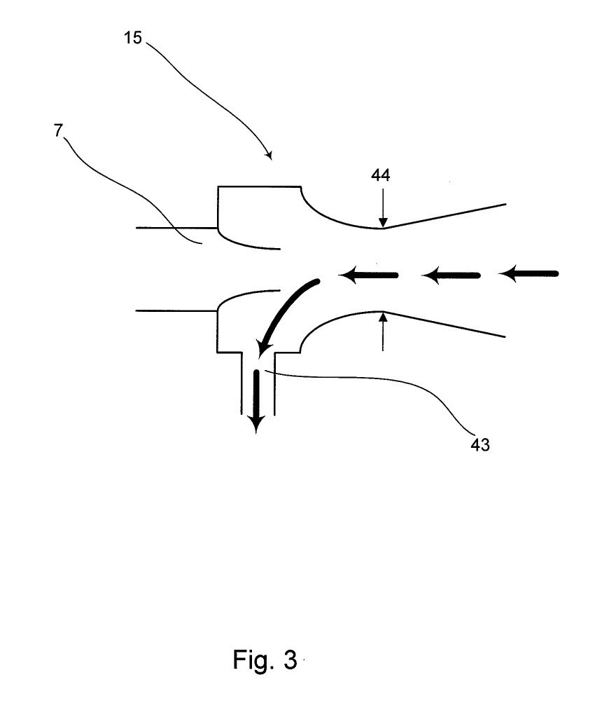

The system comprises an ejector 15 which acts as both an air inlet and an air outlet. The ejector is arranged downstream of the regulator 9. The principles of an ejector are schematically illustrated in FIGS. 2 and 3. For clarification, the ejector of FIG. 2 will be discussed first and then the description of the system shown in FIG. 1 will be continued.

The ejector 15 shown in FIG. 2 comprises a main airflow 11, which flows from the left in the figure to the right. The main airflow is depicted by white arrows and corresponds to the airflow from the source of pressurised air 5 to the fuel tank 2. The ejector also comprises a throttling 43, which can act as an air inlet or an air outlet depending on the size of the main airflow 11. In FIG. 1, when air flows in the direction to the right in the figure, the throttling acts an air inlet. When the airflow 11 arrives in the ejector 15, an underpressure arises which sucks in ambient air 41 through the throttling 43. The ambient air 41 is depicted by black arrows. The ambient air mixes with the main air flow 11 and increases the resulting airflow 45 from the ejector, which passes the smallest intersection area, called the throat 44, in the blending chamber of the ejector. In this case the ejector 15 acts as a pump.

Back to FIG. 1. When the pressure inside the tank 2 is too low, the ejector 15 contributes to introduce air into the tank. A larger throat 44 implies that the resulting airflow 45 increases. Thus, it is preferable to have a large throat 44 when the ambient pressure suddenly rises, due to e.g. a diving manoeuvre, since the pressure inside the tank will be adjusted more rapidly.

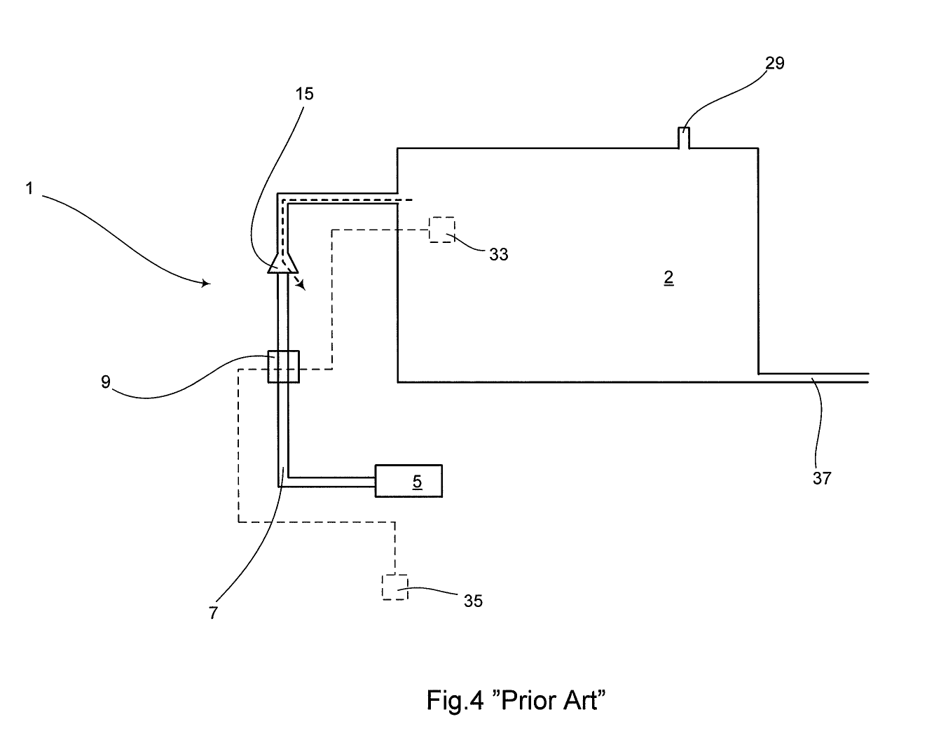

When the pressure inside the tank gets higher than the desired value, due to e.g. a climbing manoeuvre, the regulator 9 prevents air to flow towards the fuel tank 2. This case is illustrated in FIG. 3 and in FIG. 4. FIG. 3 shows the same ejector 15 as the ejector 15 in FIG. 2, but in FIG. 3 there is no main airflow 11. Without a main airflow, no underpressure arises and no air is sucked in through the throttling 43 of the ejector 15. Instead the ejector throttling 43 acts as an outlet for the air inside the tank 2. Therefore when the pressure inside the tank 2 is higher than desired, air leaks out from the tank 2 through the same throttling 43 that is used to suck in air when the pressure inside the tank 2 is too low. Hence, also when the ambient pressure suddenly falls it is preferable to have a large throat 44 since the overpressure will be adjusted more rapidly. This situation is showed in FIG. 4.

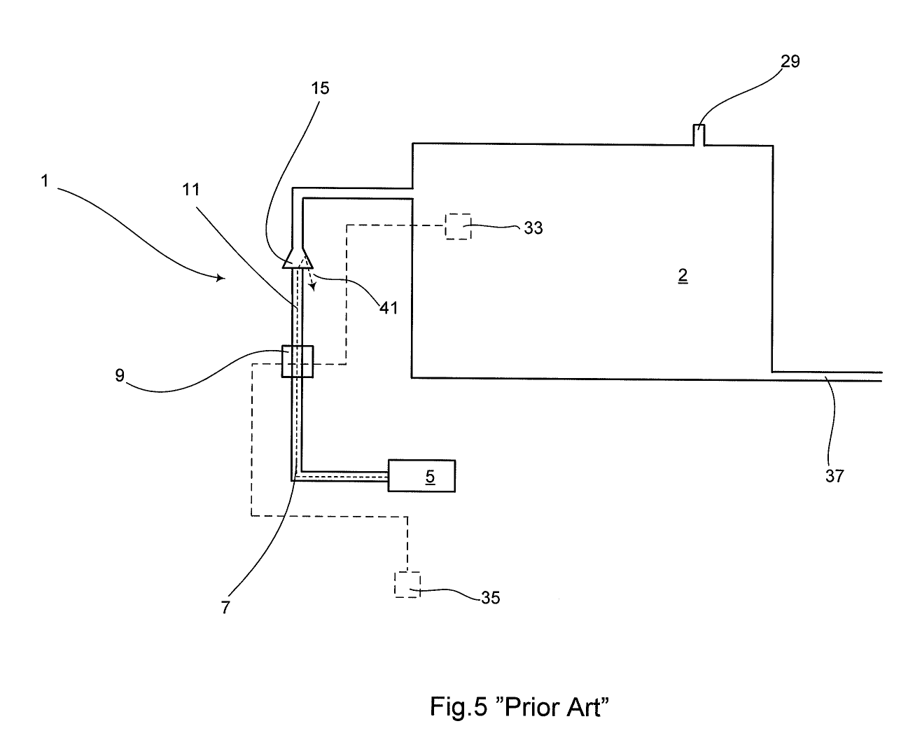

In a static condition, when the relative pressure between difference between the pressure inside the tank 2 and the ambient pressure is the desired, the regulator 9 permits a certain airflow 11 towards the tank 2. The air flowing towards the ejector 15 then bounces against the air in the blending chamber inside the ejector, keeping a balance, proportional to the size of the throat 44 in the blending chamber, between the amount of main airflow 11 and the pressure in the volume 2, and flows out through the throttling 43. Hence, the main airflow 11 that comes from the regulator 9 equals the airflow that leaks out through the throttling 43. This situation is shown in FIG. 5. It should therefore be apparent that in a static condition it is preferable to have a throat 44 that is as small as possible, since otherwise a lot of pressurised air is wasted, and as stated before, the amount of pressurised air on an aircraft is limited.

This system according to the prior art work acceptably when the tank volume is relatively small because then the source of pressurized air will suffice to keep the relative pressure on a desired value. However, with a larger tank volume the requirements for pressurised air will exceed the possible, especially when the fuel level decreases and the volume left over for the air increases. A smaller size of the throat 44 would save pressurised air when the ambient pressure is static, but the pressure levels in the tank cannot be adapted to the changes of ambient pressure when the aircraft flies aggressively. From the discussion above it should be clear that it would be optimal if the size of the throat could vary according to different situations so that on one hand a maximum flow can enter or leave the volume when the ambient pressure increases or decreases rapidly and on the other hand a minimum of pressurized air is used to keep the pressure during a static condition.

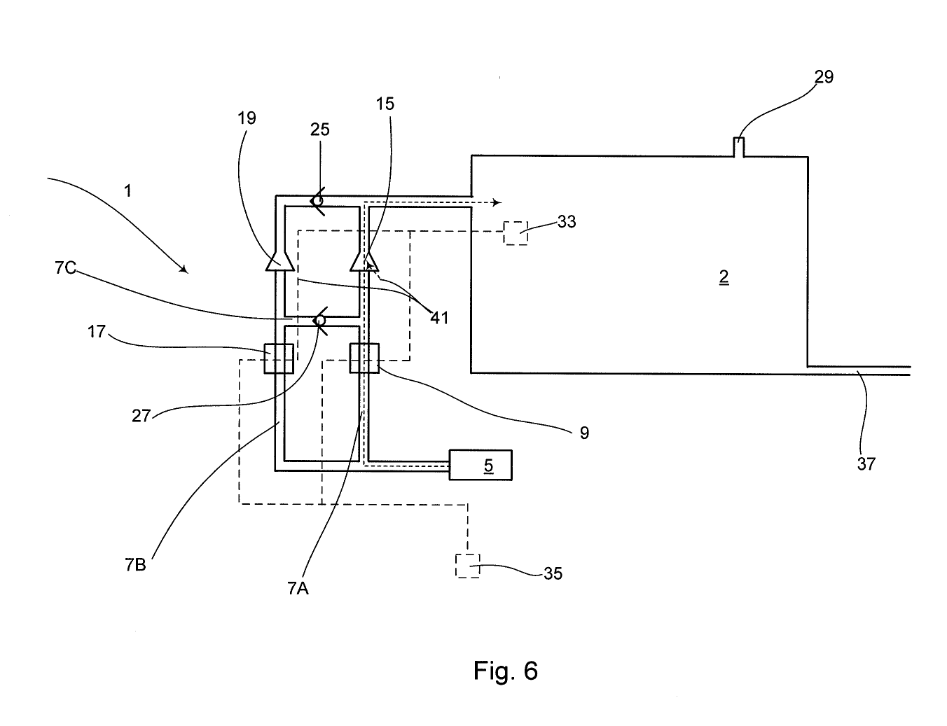

The present invention tries to overcome the drawbacks of the system according to the prior art. The system according to the invention is shown in FIGS. 6-10. The figures show the same system but the airflow differs depending on different pressure situations. The system of the invention resembles the system presented in FIG. 1 and in FIGS. 3-4, but the system of the invention has one second, additional, regulator 17 and a second, additional, ejector 19. The first regulator 9 and the first ejector 15 are arranged on a first part 7A of the conduit system and the second regulator 17 and the second ejector 19 are arranged in parallel to the first regulator 9 and the first ejector 15 on a second part 7B of the conduit system. The system of the invention is also provided with one upper check valve 25 arranged downstream of the second ejector 19 on the second part 7B of the conduit system. This upper check valve 25 is always open in a direction from the left to the right, and closed in the opposite direction. Another check valve 27 can be arranged on a third part 7C of the conduit system, which is arranged downstream of the two regulators 9 and 17 and connects the first part 7A of the conduit system with the second part 7B of the conduit system. This lower check valve 27 is closed in both directions in a normal situation. Its working principles will be discussed later.

The regulation is divided between the two regulators 9 and 17 that work with different desired values for the controlled variable, similar to the split range control principle. When the flow demand towards the volume is low, only the first regulator 9 opens up and when the flow demand is high, both regulators 9 and 17 open up. The benefit is that only the ejector 15 is used during a static condition, which minimises the amount of leaking air. When the airflow demands are high the second regulator 17, together with the second ejector, 19 open up which means that the capacity for delivering air into the volume is doubled.

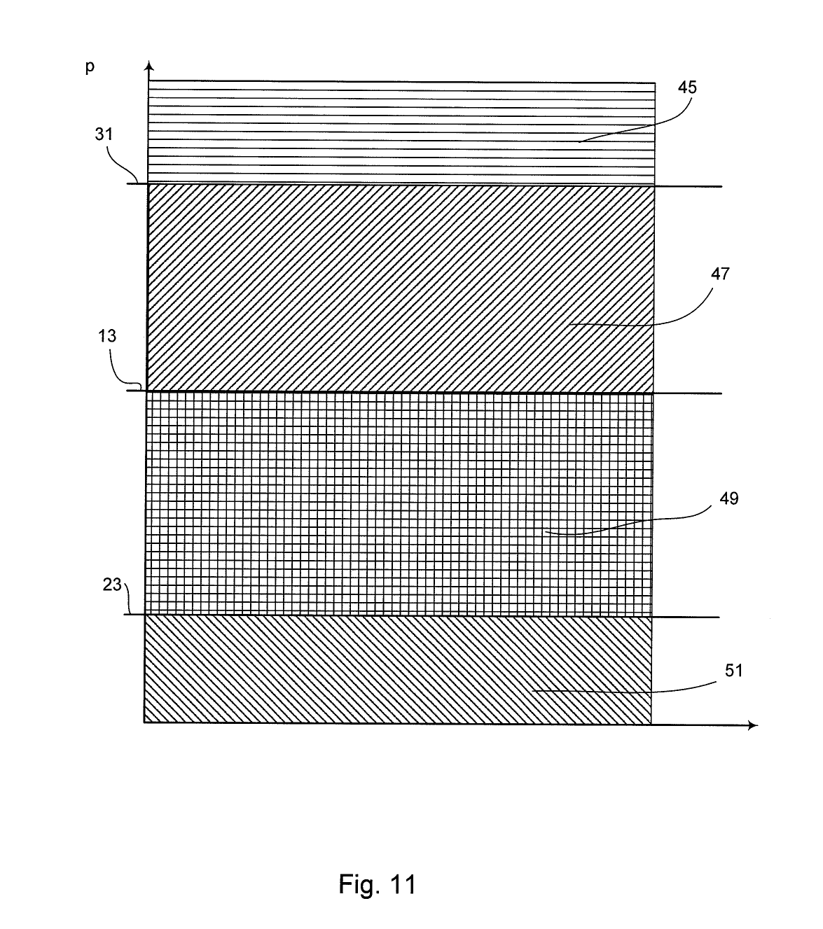

The system works differently depending on the relative pressure difference between the pressure inside the volume and the ambient pressure. FIG. 11 shows a diagram with the relative pressure drawn on the vertical axis. The pressure scale is divided into four pressure intervals 45, 47 49 and 51 separated by a first 13 a second 23 a and third 31 relative pressure difference value.

The first relative pressure difference value 13 is the desired value for the first regulator 9. The second relative pressure difference value 23 is the desired value for the second regulator 17. The third relative pressure difference value 31 is the pressure value for the triggering of a security valve 29.

When the pressure difference between the inside of the volume and the ambient air is lower than the first relative pressure difference value 13 i.e. the relative pressure lies within the interval 49, the first regulator 9 tries to raise the pressure within the volume in order to obtain the desired value 13. Since the second regulator 17 has a lower desired value 23, this regulator 17 states that the relative pressure lays above its desired value 23. Therefore the regulator 17 does not permit any air to flow through the second part 7B of the conduit system, so the second part 7B of the conduit system is closed. Thus, when the relative air pressure lies within the interval 49, the system according to the invention works in the same way as the system according to the prior art. This situation is shown in FIG. 6.

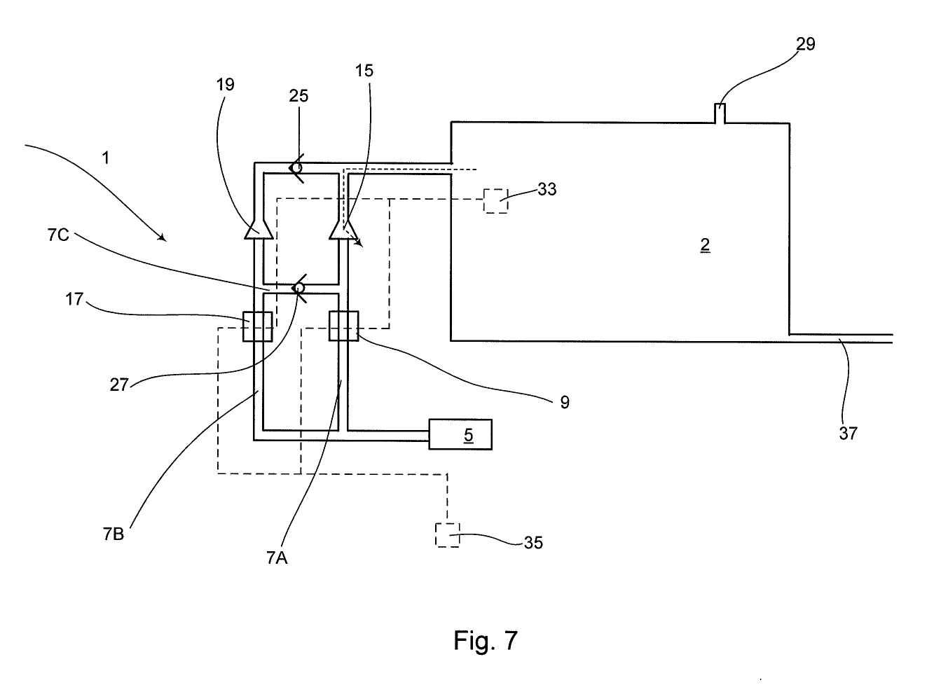

When the pressure difference between the inside of the volume and the ambient air is higher than the first relative pressure difference value 13 and lower than the third relative pressure difference value, i.e. the relative pressure lies within the interval 47, air is leaking out from the volume through the throttling 43 in the first ejector 15. This situation is shown in FIG. 7 and happens when the aircraft is climbing higher. The upper check valve 25 prevents air from leaking out through the second ejector 19. Thus, when the relative air pressure is within the interval 47, the system according to the invention works in the same way as the system according to the prior art.

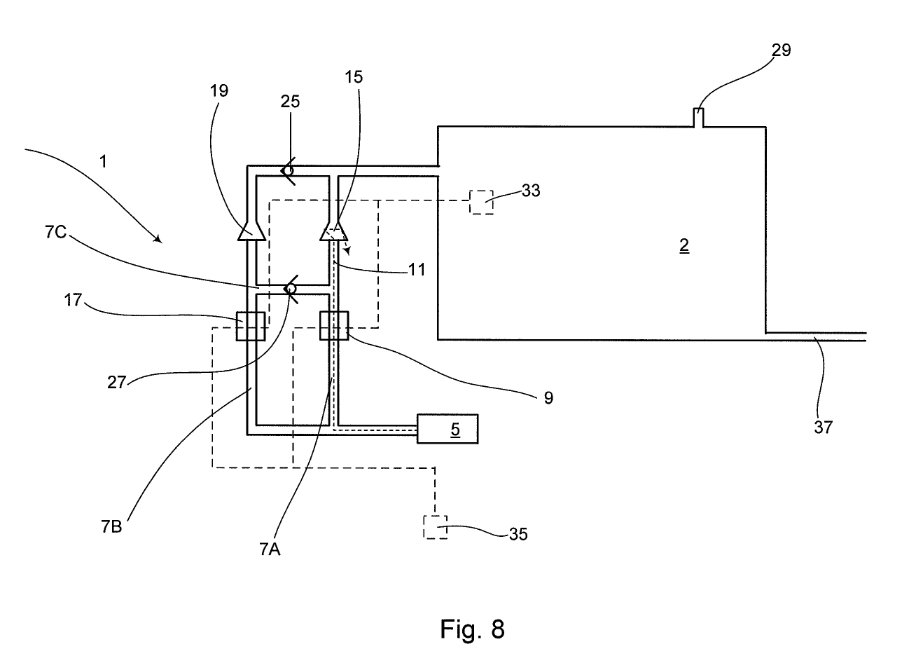

When the pressure difference is the same as the desired value for the first regulator 9 (i.e. corresponds to the first relative pressure difference value 13) the pressure condition is static. This situation is shown in FIG. 8. The second regulator 17 finds the relative pressure difference higher than desired, so the second regulator 17 does not permit any air to flow through the second part 7B of the conduit system. Only the first regulator 9 and the first ejector 15 work. The air flowing from the first regulator 15 towards the ejector 15 bounces against the air in the blending chamber inside the ejector, keeping a balance, proportional to the size of the throat 44 in the blending chamber, between the amount of main airflow 11 and the pressure in the volume 2, and flows out through the throttling 43 in the ejector 15. In this static situation only one ejector is used, which minimises the air leaks. The system according to the invention still works in the same way as the system according to the prior art.

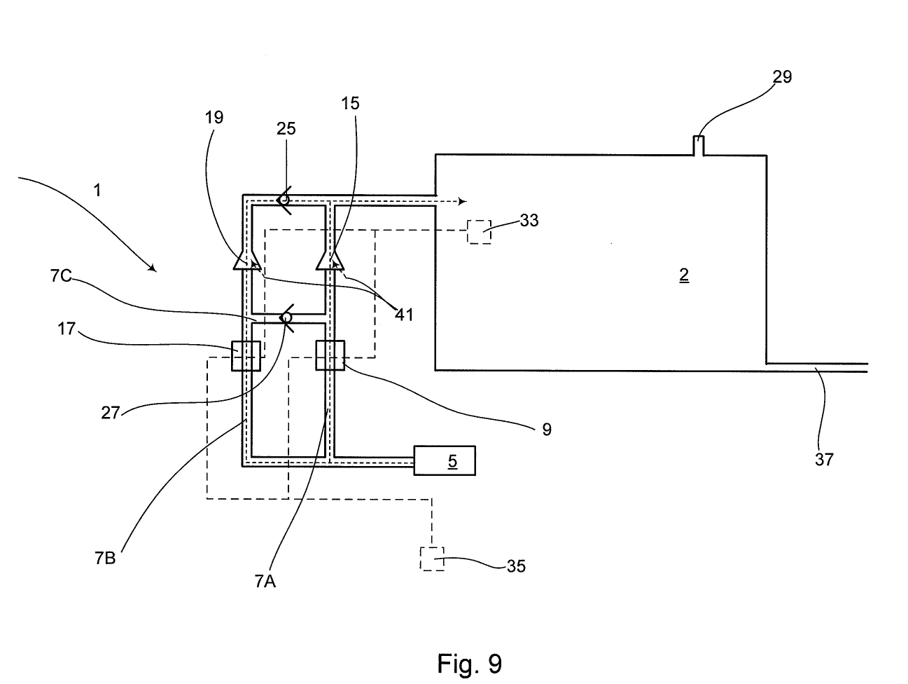

However, when the pressure difference between the inside of the volume and the ambient air is lower than the second relative pressure difference value 23 i.e. the relative pressure lies within the interval 51, both the first regulator 9 and the second regulator 17 try to raise the pressure within the volume 2. This situation is shown in FIG. 9 and it occurs when the ambient pressure increases fast and much like e.g. in a diving manoeuvre. In this situation it is very important to quickly raise the pressure within the volume. The first regulator 9 aims at obtaining a relative pressure corresponding to the first relative pressure difference value 13 and the second regulator 17 aims at obtaining a relative pressure corresponding to the second relative pressure difference value 23. The simultaneous use of two regulators 9 and 17 and two ejectors 15 and 19, solves the problem of efficiently increasing the pressure within the volume 2 when the demand for airflow is high.

Calculations performed indicate that one side effect that occurs when the airflow is divided to pass through two ejectors is that more ambient air is sucked into the resulting air flow in comparison to if one ejector, with a throat 44 having a doubled cross section area, had been used.

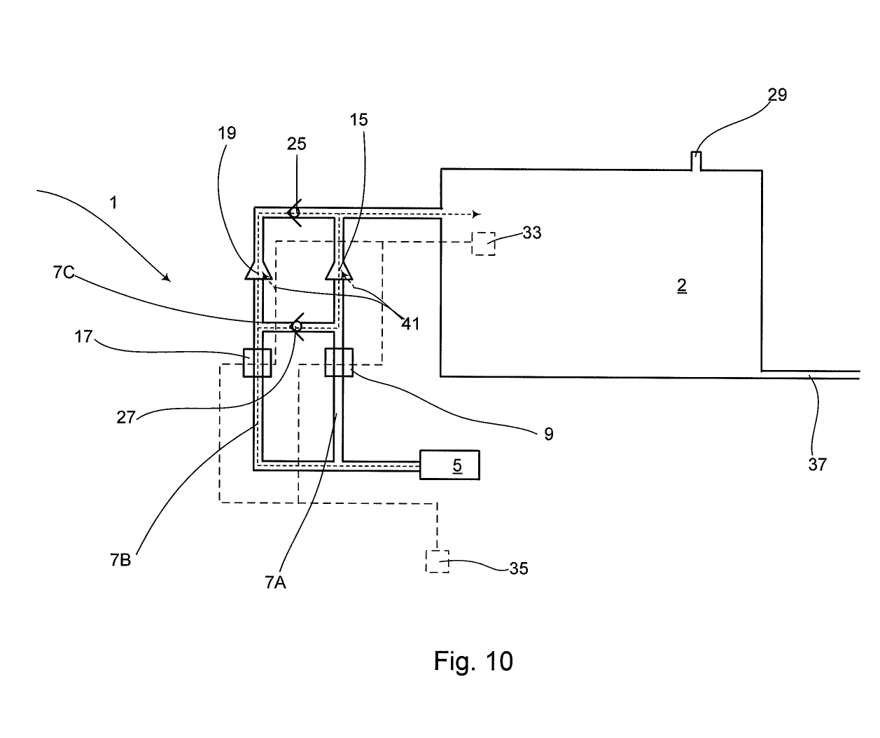

If the second regulator 17 fails, the system will still work in the same manner as the system of the state in the prior art. But, if the first regulator 9 fails and the second regulator 17 works, no main airflow 11 enters through the first ejector 15. This means that the air coming from the second regulator 17, flowing through the second ejector 19, can continue out through the throttling 43 in the first ejector 15 and that no air enters the volume 2. To prevent this situation the lower check valve 27 opens up if the first regulator 9 fails. This means that air can flow through the check valve 27 in the direction from the left to the right but not in the opposite direction. Air coming from the second regulator 17 can then take two ways. A first way through the second ejector 19 and a second way, through the lower check valve 27, into the first ejector 15 and prevent air from leaking out through the throttling 43 in the first ejector 15. This situation is showed in FIG. 10.

The security valve 29 opens up if the pressure inside the volume 2 reaches dangerous levels. This is the case when the relative pressure exceeds the third relative pressure level 31 and it happens if, for some reason, the regulators are open despite a high pressure in the volume 2 or might occur if the throttling 43 in the ejector 15 is clogged.

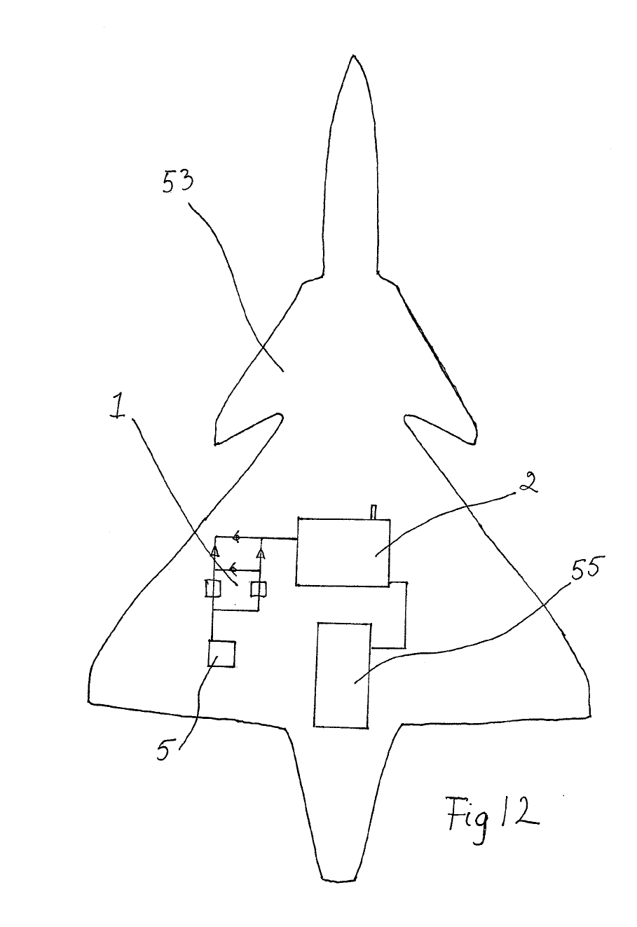

FIG. 12 shows the system 1 according to the present invention when it is used on an aircraft 53. Air flows from the source of pressurized air 5, through the system 1, towards the fuel tank 2, which contains air and fuel. The fuel is used by the engine 55 of the aircraft 53.

The figures in this application show a system with two parallel regulators and ejectors, where each regulator works towards different desired pressure values. It is of course possible to have more than two parallel regulators and ejectors where each regulator works with a separate desired pressure value.

It should be obvious to the reader that the system and method are not intended to be limited to be used on fuel tanks on aircrafts. Instead, the scope of the present invention is limited by the technical features described in the claims.

1-10. (canceled)

11. System (1) for pressurizing a volume (2) that needs to have a relative air pressure, in comparison with an ambient pressure, within a specified interval, said system comprising:
a source of pressurized air (5);
a conduit system (7) configured to delivery pressurized air from the source and into the volume;
a first sensor (33) configured to measure an air pressure inside the volume;
a second sensor (35) configured to measure the ambient pressure;
a first regulator (9) arranged on a first part (7A) of the conduit system, which first regulator is configured to regulate a first airflow from the source of pressurized air (5) to the volume (2) through the first part (7A) of the conduit system, in order to obtain a first relative pressure difference value (13) between the air pressure inside the volume (2) and the ambient pressure;
a first ejector (15) arranged on the first part (7A) of the conduit system, downstream of the first regulator (9);
a second regulator (17) arranged in parallel to the first regulator (9) and the first ejector (15) on a second part (7B) of the conduit system, which second regulator is configured to regulate a second airflow from the source of pressurized air (5) to the volume (2) through the second part (7B) of the conduit system, in order to obtain a second relative pressure difference value (23) between the air pressure inside the volume (2) and the ambient pressure;
a second ejector (19) arranged on the second part (7B) of the conduit system, downstream of the second regulator (17); and
an upper check valve (25) arranged on the second part (7B) of the conduit system and downstream of the second ejector (19), blocking airflow from the volume (2) into the second ejector (19).

12. The system (1) according to claim 11, wherein the system (1) comprises a lower check valve (27) arranged on a third part (7C) of the conduit system, which lower check valve is arranged downstream of the two regulators (9, 17) and connects the first part (7A) of the conduit system with the second part (7B) of the conduit system.

13. The system (1) according to claim 11, wherein the volume (2) comprises at least one security valve (29), which at least one security valve relieves air when the relative pressure difference between the pressure inside the volume (2) and the ambient pressure exceeds a predefined value (31).

14. The system (1) according to claim 11, wherein the system (1) is used on an aircraft.

15. The system (1) according to claim 14, wherein the volume (2) is a fuel tank.

16. A method for pressurizing a volume (2) that needs to have a relative air pressure, in comparison with an ambient pressure, within a specified interval, said method comprising the steps of:
measuring a pressure within the volume (2);
measuring an ambient pressure outside of the volume (2);
determining a pressure difference between the pressure inside the volume and the pressure outside of the volume;
if the pressure difference exceeds a first relative pressure difference value (13), relieving the air pressure within the volume by letting air flow out from the volume (2) through a first ejector (15);
if the pressure difference between the pressure inside the volume and the pressure outside of the volume is below the first relative pressure difference value (13):
using a first regulator (9) arranged upstream of the first ejector (15) to regulate a first airflow from a source of pressurized air (5) through the first regulator (9) into the volume (2) in order to obtain the first relative pressure difference value (13) between the pressure inside the volume (2) and the ambient pressure; and
using the airflow through the first ejector (9) to suck in additional ambient air (41) through the first ejector (15) and add it to the first airflow into the volume (2); and
if the pressure difference between the pressure inside the volume (2) and the pressure outside of the volume (2) is below a second relative pressure difference value (23), which is lower than the first relative pressure difference value:
using a second regulator (17) arranged in parallel to the first regulator (9) and the first ejector (15) to regulate a second airflow through the second regulator (17) into the volume (2) in order to obtain the second relative pressure difference value (23) between the pressure inside the volume (2) and the ambient pressure; and
using the airflow through a second ejector(19), which is arranged downstream of the second regulator (17), to suck in additional ambient air (41) through the second ejector (19) and add it to the second airflow into the volume (2).

17. A method according to claim 16, further comprising the step of, if the first regulator (9) fails and no air passes through the first regulator (9), establishing a flow connection between the second regulator 17) and the first ejector (15) so that the two ejectors (15, 19) are arranged in parallel, downstream of the second regulator (17).

18. A method according to claim 16, further comprising the step of, if the pressure difference between the pressure inside the volume (2) and the pressure outside of the volume (2) is above a third relative pressure difference value (31), relieving the air pressure within the volume (2) by letting airflow out from the volume through at least one security valve (29).

19. A method according to claim 16, wherein the method is used to regulate a volume (2) in an aircraft.

20. A method according to claim 19, wherein the volume (2) is a fuel tank.
